(19) United States
(12) Patent Application Publication
(10) Pub. No.: US 2026/0125986 A1
(43) Pub. Date: May 7, 2026

(54) TURBINE SEALING RING THAT IS REMOVABLE UPSTREAM

(71) Applicant: SAFRAN AIRCRAFT ENGINES, Paris (FR)

(72) Inventors: Patrick Jean Laurent SULTANA, Moissy-Cramayel (FR); Thierry FACHAT, Moissy-Cramayel (FR); Matthieu SIMON, Moissy-Cramayel (FR)

(73) Assignee: SAFRAN AIRCRAFT ENGINES, Paris (FR)

(21) Appl. No.: 19/122,978

(22) PCT Filed: Oct. 16, 2023
(86) PCT No.: PCT/FR2023/051605

§ 371 Date: Apr. 21, 2025

(30) Foreign Application Priority Data
Oct. 24, 2022 (FR) FR2211012

(51) Int. Cl. F01D 11/08; F01D 25/24

(52) U.S. Cl. CPC F01D 11/08; F01D 25/246; F05D 2230/70; F05D 2240/11; F05D 2250/75; F05D 2260/30

(57) ABSTRACT

Turbine for a turbomachine comprising an annular casing (1), upstream (3) and downstream (4) ring supports and a sealing ring (2) configured to extend around and radially face a blade assembly (6) of a rotor of the turbine,
the supports are mounted against a radially inner surface of the casing (1),
the sealing ring (2) being configured to be disposed radially between the blade assembly (6) and the casing (1), and being mounted against the upstream support and the downstream support,
the sealing ring (2) having a maximum radius with respect to the main axis (X) of the turbine, and
the casing (1) being dimensioned such that the maximum radius of the sealing ring (2) is strictly smaller than the radius of the upstream end of the casing (1) so as to allow a mounting by axial insertion, of the sealing ring (2) and of the upstream ring support (3), against the downstream ring support (4).

### TECHNICAL FIELD

The present disclosure concerns a sealing ring for a turbomachine turbine, particularly a sealing ring for a turbine that can be dismounted from upstream.

### PRIOR ART

The maintenance constraints of turbomachine turbines are known, requiring access to pieces internal to the turbines.

For example, the low-pressure turbine blades are generally difficult to access for maintenance operations.

In order to facilitate the maintenance, and thus reduce operating costs, turbomachines have been provided with a sealing ring that can be dismounted from upstream.

However, the possibility of dismounting the sealing ring from upstream is generally to the detriment of the sealing capacity of the sealing ring, and thus of increased fuel consumption.

### DISCLOSURE OF THE INVENTION

The present disclosure aims to propose a turbine aimed at solving the problems above.

To this end, the present disclosure concerns a turbine for a turbomachine, the turbine having a main axis and comprising a casing, typically an annular casing, an upstream ring support, a downstream ring support, a sealing ring, the sealing ring being configured to extend around and radially face a blade assembly of a rotor of the turbine, in which:
the upstream ring support and the downstream ring support are mounted against a radially inner surface of the casing, the upstream ring support and the downstream ring support having an upstream end and a downstream end,
the sealing ring being configured to be disposed radially between the blade assembly and the casing, and being mounted against the upstream ring support and the downstream ring support,
the sealing ring having a maximum radius with respect to the main axis, and
the casing being dimensioned such that the maximum radius of the sealing ring is strictly smaller than the radius of the upstream end of the casing so as to allow a mounting by axial insertion, of the sealing ring and of the upstream ring support, against the downstream ring support.

In the present disclosure, the terms “axial”, “radial”, “circumferential”, “internal”, “external” and their derivatives are defined relative to the main axis of the turbomachine; finally, the terms “upstream”, “downstream”, “front” and “rear” are defined relative to the main axis, along the general direction of circulation of the fluid within the turbomachine. By “extends axially, radially or circumferentially” it is meant “extends along a direction having a non-zero component along an axial, radial or circumferential direction”, respectively. A circumferential direction is perpendicular to the axial direction and to a radial direction. The main axis of the turbomachine corresponds to the axis of rotation of the turbomachine.

In some embodiments, the upstream ring support is circumferential, preferably over 360°. Preferably, the upstream ring support is continuously mounted bearing against a radially inner surface of the casing, along a circumference.

In some embodiments, the downstream ring support is circumferential, preferably over 360°. Preferably, the downstream ring support is sectorized.

By upstream ring support and by downstream ring support, it is meant respectively an upstream support, and a downstream support.

Such a dimensioning of the sealing ring and of the casing makes it possible, after dismounting the upstream ring support, to dismount the sealing ring by translation along the main axis towards the upstream without the casing being an obstacle.

Particularly, the mounting from the front can be carried out without tilting, allowing a more accurate, faster mounting with a reduced risk of damage to pieces.

Naturally, unless otherwise stated, any characteristic described relating to a dismounting operation is also applicable to a mounting operation carried out in the reverse order, and vice versa.

The dismounting of the sealing ring from upstream thus reduces maintenance time and costs compared to a turbine whose sealing ring can only be dismounted from downstream.

The bearing of the sealing ring on the supports ensures the centering of the sealing ring, thus reducing the relative wear of the pieces while being compatible with the dismounting of the sealing ring from upstream.

According to one example, the bearing of the sealing ring on the upstream ring support is a radial bearing. According to one example, the bearing of the sealing ring on the downstream ring support is a radial bearing.

By radial bearing it is meant a bearing on a surface whose normal has a non-zero radial component.

According to one example, the radial bearing has a positive or zero component along the main axis towards the upstream, further facilitating the dismounting from upstream.

According to one example, in addition to or as a replacement, the sealing ring has an axial bearing on the upstream ring support. According to one example, the sealing ring has an axial bearing on the downstream ring support.

By axial bearing it is meant a bearing on a surface whose normal has a non-zero axial component.

The axial bearing makes it possible to ensure the axial holding on the upstream ring support.

In some embodiments, the turbine comprises at least one seal disposed between the downstream ring support and the radially protruding portion.

The seal between the downstream ring support and the radially protruding portion ensures the sealing despite differential thermal expansion within the turbine resulting in relative displacements, in particular between the sealing ring and the downstream ring support, which can be compensated by deformation of the seal. The differential thermal expansion results from temperature deviations between the ring and the downstream ring support as well as from materials with different thermal expansion coefficients.

According to one example, the seal is an axial seal, that is to say extending axially between two contact surfaces.

The use of an axial seal is compatible with the centering by the sealing ring and the downstream ring support, and the relative axial displacements between the sealing ring and the downstream ring support thus being limited, which reduces the shear forces applied to the seal and improves its service life. A fortiori, the use of an axial seal at the level of a radial bearing between the downstream ring support and the sealing ring allows for increased sealing and the shear forces applied to the seal are reduced as much as the bearing direction between the downstream ring support and the sealing ring and the direction along which the seal extends forms an angle close to 90°.

In some embodiments, the seal is in direct contact with the downstream ring support and the radially protruding portion.

According to one example, the seal is sectorized. In the case where at least one piece among the sealing ring and the downstream ring support is sectorized, the seal is sectorized similarly to said piece, that is to say including sectors at circumferential positions common to the sectors of said piece.

Each sector of a sectorized seal can move and deform more independently than for a non-sectorized seal, making it possible to ensure better sealing performance.

According to one example, the seal is an omega seal. By omega seal it is meant a seal whose cross-section has a shape similar to the omega symbol (Ω). A cross-section of an omega seal may have an open contour or a closed contour. An omega seal may also refer to an accordion-shaped seal, that is to say formed from a succession of folds in successively alternating directions, which corresponds to the junction of a plurality of omega seals with open contours.

An omega seal, and a fortiori an accordion-shaped seal, makes it possible to preserve the sealing over a wide range of deformation while ensuring a satisfactory sealing level.

In some embodiments, the casing is a low-pressure turbine casing.

The possibility of dismounting from upstream is particularly desirable for a low-pressure turbine casing, in order to facilitate the maintenance operations.

In some embodiments, the blade assembly comprises a ceramic-matrix composite (CMC) material. A CMC material generally comprises a fiber reinforcement within an at least partly ceramic matrix.

The use of a ceramic-matrix composite material allows the blade assembly to undergo higher temperatures than a blade assembly made of metal material, thus making it possible to reduce the air flow rate taken from the high-pressure compressor necessary for cooling the blade assembly, which makes it possible to improve the specific consumption of the turbomachine, and allows the turbomachine to operate at a higher temperature, resulting in better efficiency of the turbomachine. Furthermore, the ceramic-matrix composite materials have a lower density than metal materials, which allows a mass gain reducing the consumption of the turbomachine.

Compared to blade assemblies made of metal material, the blade assemblies made of CMC materials may be sensitive to FOD (Foreign Object Damage) or DOD (Domestic Object Damage) damages, in this case internal to the turbomachine. Maintenance made easier by the upstream mounting is therefore particularly desirable in the case of using a CMC blade assembly.

In some embodiments, the sealing ring is sectorized.

In some embodiments, at least one support among the upstream ring support and the downstream ring support is sectorized.

By sectorized it is meant formed of sectors connected to each other. In this case, by sectorized it is meant sectorized along a circumferential direction about the main axis, that is to say formed of sectors extending along a circumference and connected to each other.

The sectorized sealing ring is less prone to the thermal expansion than a non-sectorized sealing ring, thus minimizing the relative displacements between the sealing ring and other pieces internal to the turbine during the service life of the turbine, thus facilitating the control of the end clearance of the blade assembly with respect to the sealing ring and ensuring good thermal performance and maintenance of the sealing of the turbomachine.

Associated with one (or more) support(s) also sectorized, the support(s) is (are) also less prone to thermal expansion, further improving the control of the end clearance of the blade assembly. The reduction of the displacements associated with a reduced thermal expansion also makes it possible to reduce an amplitude of deformations applied to intermediate pieces, for example a seal, thereby reducing its fatigue damage.

In some embodiments, the turbine comprises at least one locking member configured to hold together a downstream end of the sealing ring and the downstream ring support. According to one example, the locking member is C-shaped and configured to hold together in contact, inside the C-shape, a downstream end of the sealing ring and the downstream ring support.

In some embodiments, the turbine comprises at least one locking member configured to hold together an upstream end of the sealing ring and the upstream ring support. According to one example, the locking member is C-shaped and configured to hold together in contact, inside the C-shape, an upstream end of the sealing ring and the upstream ring support.

The locking member ensures the downstream and/or upstream centering of the sealing ring, thus held in position within the turbine.

In some embodiments, the locking member is a clip.

Such a locking member is compatible with stable locking and easy removal prior to a maintenance operation on the blade assembly.

In some embodiments, the sealing ring comprises a radially protruding portion, the maximum radius of the sealing ring being equal to the maximum radius of the radially protruding portion from the main axis, that is to say the distance from the main axis of the position of the radially protruding portion furthest from the main axis.

In other words, the sealing ring comprises a radially protruding portion, the maximum radius of the sealing ring being measured on the radially protruding portion.

In some embodiments, at least one sealing metal sheet is provided between the seal and the downstream ring support and/or between the seal and the radially protruding portion.

The metal sheet ensures good contact with the seal, thereby ensuring the sealing performance.

According to one example, the metal sheet is a circumferential metal sheet. A circumferential metal sheet provides the seal with a larger bearing surface, improving its efficiency and reducing its wear.

According to one example, the metal sheet is a non-sectorized circumferential metal sheet. For example, the metal sheet is invariant by rotation about the main axis.

In the case of a sectorized sealing ring and of a non-sectorized metal sheet, the thermomechanical performance of the sectorized sealing ring is preserved without degrading the sealing, ensured by the seal.

According to one example, the metal sheet is detachably mounted on the radially protruding portion, for example the metal sheet is clipped onto the radially protruding portion.

According to one example, the metal sheet is in direct contact with the seal and one among the downstream ring support and the radially protruding portion.

By extension, the measurement of the maximum section of the sealing ring (therefore also of the radially protruding portion) includes the metal sheet mounted on the sealing ring.

In some embodiments, the turbine comprises a metal sheet mounted between the seal and the downstream ring support.

The metal sheet between the seal and the front ring support ensures the downstream centering by the downstream ring support.

In some embodiments, at least one among a downstream end of the sealing ring and a downstream end of the downstream ring support is received in a housing of an external platform of a downstream distributor. By downstream distributor, it is meant for example a distributor downstream of the sealing ring.

In some embodiments, the housing is a groove into which the at least one end is inserted axially.

The present disclosure also concerns a turbomachine comprising the turbine according to the present disclosure.

### BRIEF DESCRIPTION OF THE DRAWINGS

Other characteristics and advantages of the object of the present disclosure will emerge from the following description of embodiments, given as non-limiting examples, with reference to the appended figures.

FIG. 1 is a half-section view of a turbomachine.

FIG. 2 is a schematic representation in a cross-sectional view comprising the main axis of a low-pressure turbine according to a first embodiment.

FIG. 3 is a schematic representation in a cross-sectional view comprising the main axis of a low-pressure turbine according to a second embodiment.

FIG. 4 is a schematic representation in a cross-sectional view comprising the main axis of a low-pressure turbine according to a third embodiment.

FIG. 5 is a schematic representation in a cross-sectional view comprising the main axis of a low-pressure turbine according to a fourth embodiment.

### DESCRIPTION OF THE EMBODIMENTS

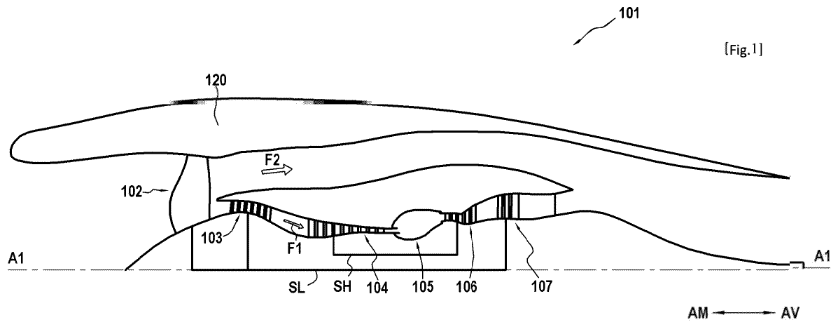

FIG. 1 represents a turbomachine 101 in longitudinal half-section along a plane passing through its main axis A1-A1. The turbomachine 101 is a dual-spool turbofan turbomachine, but other turbomachines can accommodate a turbine according to one embodiment.

The turbomachine 101 comprises, from upstream to downstream depending on the circulation of the air stream, a fan 102, a low-pressure compressor 103 (also called booster), a high-pressure compressor 104, a combustion chamber 105, a high-pressure turbine 106, and a low-pressure turbine 107. These different elements are installed inside a nacelle 120, so as to obtain a propulsion assembly comprising the nacelle 120 and the turbomachine 101.

Downstream of the fan 102, the air stream is divided into a first air stream part (also called primary stream) F1 passing through the low-pressure compressor 103, and a second air stream part (also called secondary stream) F2 flowing in a bypass around the low-pressure compressor 103.

The fan 102 and the low-pressure compressor 103 are driven by the low-pressure turbine 107 via a low-pressure main shaft SL, while the high-pressure compressor 104 is driven by the high-pressure turbine 106 via a high-pressure main shaft SH. The low-pressure main shaft SL typically extends inside the high-pressure main shaft SH.

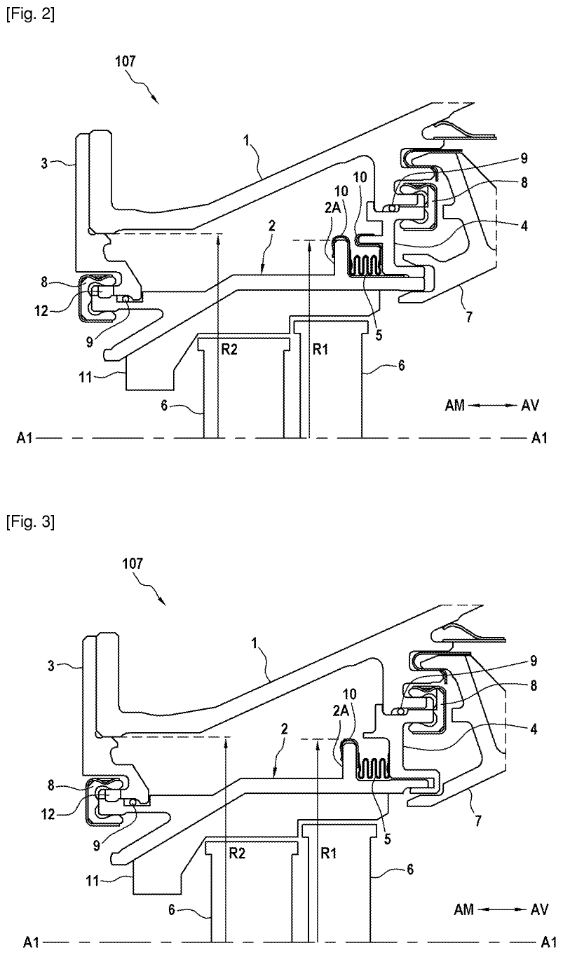

The structure of the low-pressure turbine 107 will be described in more detail relative to FIG. 2, the embodiments of FIGS. 3 to 5 will be described as variants of FIG. 2.

In FIGS. 2 to 5, the upstream direction is symbolized by the reference AM, and the downstream direction is symbolized by the reference AV.

As represented in FIG. 2, the low-pressure turbine 107 comprises a casing 1, an upstream ring support 3 (or upstream support 3), a downstream ring support 4 (or downstream support 4), a sealing ring 2 and a blade assembly 6.

The casing 1 is an annular casing having an inner surface.

The upstream support 3 and the downstream support 4 are mounted bearing against the inner surface of the annular casing 1, thus delimiting a casing segment.

The upstream support 3 and the downstream support 4 are in contact along a surface of radial normal, thus facilitating the mounting and dismounting of the pieces relative to each other.

The upstream support 3 may have a radial protrusion abutting an upstream face of the casing 1, in order to facilitate the correct relative positioning of the different pieces of the casing 1 during the mounting.

A blade assembly 6 of a rotor of the turbine 107 is provided inside the casing 1, to draw mechanical power from the combustion gases coming from the combustion chamber by the high-pressure turbine.

The blade assembly 6 is provided in a CMC material.

The sealing ring 2 is provided radially between the blade assembly 6 and the casing 1.

An abradable element 11 may be provided between the sealing ring 2 and the blade assembly 6, making it possible to ensure better control of the tolerances relative to the blade assembly 6 and thus limit the leakage rate bypassing the blade assembly 6.

The sealing ring 2 is mounted between the upstream support 3 and the downstream support 4, bearing against the upstream support 3 and the downstream support 4.

The sealing ring 2 has a radially outermost end, at a distance R1 from the main axis.

For example, the sealing ring 2 comprises a radially protruding portion 2A, one end of which is at a radially outermost position of the sealing ring 2, at a distance R1 from the main axis.

In other words, the sealing ring 2 is included in a virtual cylinder of revolution centered on the main axis, extending axially according to positions common with the sealing ring 2 and of radius equal to the distance R1, the cylinder of revolution being tangent to the sealing ring 2 (and to the radially protruding portion 2A, where appropriate) at the radially outermost position.

The casing 1 can thus be virtually split into an upstream half of the casing 1 and a downstream half of the casing 1, where the upstream half of the casing 1 corresponds to half of the casing 1 positioned upstream of the radially outermost end of the sealing ring 2, and the downstream half of the casing 1 corresponds to half of the casing 1 positioned downstream of the radially outermost end of the sealing ring 2.

A radially innermost position of the upstream half of the casing 1 is located at a distance R2 from the main axis.

In other words, a virtual cylinder of revolution centered on the main axis and of radius equal to the distance R2, extending axially according to common positions with the upstream half of the casing 1 and of radius equal to the distance R2, is included in the upstream half of the casing 1, the cylinder of revolution being tangent to the upstream half of the casing 1 at the radially innermost position of the upstream half of the casing 1.

The distances R1 and R2 are provided such that R1<R2 (“R1 strictly smaller than R2”).

Thus, the turbine is dimensioned such that the maximum section of the sealing ring 2 is strictly included in any section of the casing 1 along the main axis upstream of the main axis.

In other words, it is possible to construct a virtual infinite half-cylinder containing the sealing ring 2 and extending infinitely towards the upstream without intersecting or forming a tangent with the upstream half of the casing 1.

In other words, the turbine is dimensioned so that the maximum radius R1 of the sealing ring 2 is strictly smaller than the radius R2 of the upstream end of the casing 1, the upstream end corresponding to the upstream half of the casing 1.

In this way, it is possible to move the sealing ring 2 by translation towards the upstream without the sealing ring 2 coming into contact with the upstream part of the casing 1.

This also makes it possible to ensure the mounting by axial insertion of the sealing ring 2 and of the upstream ring support 3 against the downstream ring support 4.

The sealing ring 2 can then be dismounted from upstream and removed from inside the casing 1 by axial translation towards the upstream, the various means of attachment with the other pieces of the turbine, which will be described below, being previously detached and/or disassembled.

The upstream support 3 extends radially, and an internal surface of the upstream support 3 is in contact with an external surface of the sealing ring 2.

The contact surface between the internal surface of the upstream support 3 and the external surface of the sealing ring 2 can be provided between two respective ends of the upstream support 3 and of the sealing ring 2. The contact surface can be a radial contact surface.

By radial surface it is meant a surface whose normal has a non-zero radial component.

These two ends can be held against each other by a locking member 8.

The locking member 8 can for example be a C-shaped clip, that is to say a clip configured to surround the two respective ends of the sealing ring 2 and of the upstream support 3 in order to keep them in contact against each other.

The contact between the internal surface of the upstream support 3 and the external surface of the sealing ring 2 can be made by means of a seal 9.

The downstream support 4 extends radially, and an internal surface of the casing 1 is in contact with an external surface of the downstream support 4.

The contact surface between the internal surface of the casing 1 and the external surface of the downstream support 4 can be provided between two respective ends of the casing 1 and of the downstream support 4. The contact surface can be a radial contact surface.

These two ends can be held against each other by a locking member 8, for example a C-shaped clip.

The contact between the internal surface of the casing 1 and the external surface of the downstream support 4 can be made by means of a seal 9.

The contact between a locking member 8 and a surface among the two ends held against each other by the locking member 8 can be made by means of a sealing tab 12.

A downstream end of the sealing ring 2 is in contact with an end of the downstream support 4. The downstream end of the sealing ring 2 has a radial bearing surface on the end of the downstream support 4.

The radial surface between the sealing ring 2 and the downstream support 4 can be purely radial, that is to say of radial normal, or have an inclination such that the surface moves away from the main axis in the upstream direction. In this way, the contact against the radial surface does not prevent the dismounting of the sealing ring 2 from upstream.

As represented in FIG. 2, the turbine includes a distributor 7 that may have a first end inserted into an opening provided in the casing 1, and a second C-shaped end provided so as to grip the downstream end of the sealing ring 2 and the end of the downstream support 4 in contact against each other.

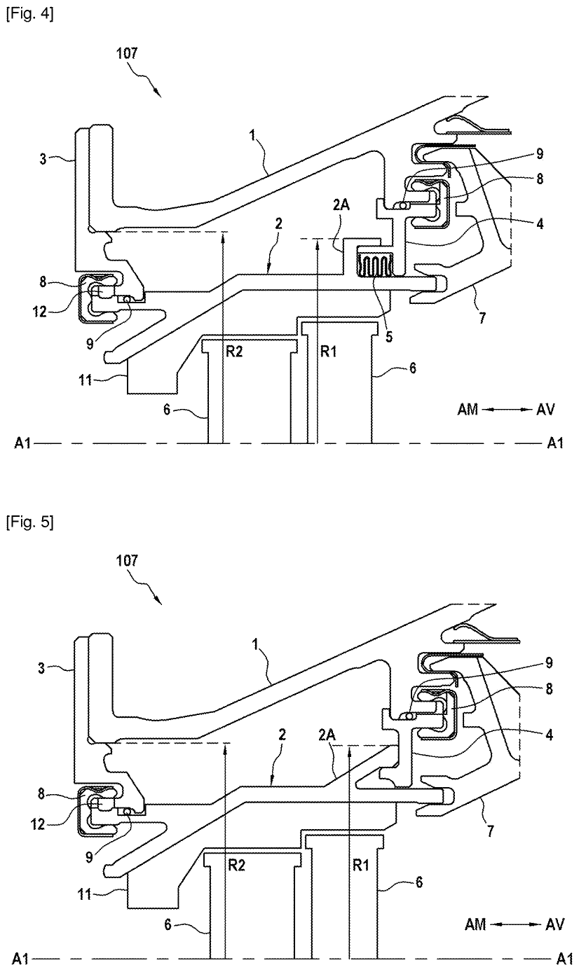

The second end of the distributor 7 may include only one branch in contact with an inner surface of the downstream end of the sealing ring 2 alone, as represented in the embodiments of FIGS. 4 and 5, or in contact with an inner surface of the end of the downstream support 4 alone.

The second end of the distributor 7 may include only one branch in contact with a radially internal surface, for example a radially internal surface of the end of the downstream support 4 as represented in the embodiment of FIG. 3, or a radially internal surface of the end of the sealing ring 2.

The end of the downstream support 4 can grip the sealing ring 2, as represented in FIG. 3. According to one example, the end of the downstream support 4 grips the sealing ring 2 so as not to prevent the dismounting from upstream.

A seal 5 is provided between the downstream support 4 and the radially protruding portion 2A.

According to one example, the seal 5 is provided between an axial surface of the downstream support 4 and an axial surface of the radially protruding portion 2A.

By axial surface, it is meant a surface whose normal has a non-zero axial component.

According to one example, in addition to or as a replacement, the seal 5 is provided between a radial surface of the downstream support 4 and a radial surface of the radially protruding portion 2A. Such additional contact allows for better holding in position

The seal 5 may for example be an omega seal, particularly an accordion-shaped seal.

The seal 5 may be in direct contact with the respective axial surfaces of the radially protruding portion 2A and of the downstream support 4.

The seal 5 may also be in contact with these surfaces via metal sheets.

The seal 5 may be in contact with at least one of the radial surfaces among the radial surface of the downstream support 4 and the radial surface of the radially protruding portion 2A, in direct contact or via metal sheets.

A metal sheet 10 may be provided against the radially protruding portion 2A. The metal sheet 10 of the radially protruding portion 2A may for example surround the radially protruding portion 2A like a C-shaped clip, in order to be held in position against the radially protruding portion 2A.

In addition or as a replacement, a metal sheet 10 may be provided against the downstream support 4. The metal sheet 10 of the downstream support 4 may for example surround a part of the downstream support 4 like a C-shaped clip, in order to be held in position against the downstream support 4.

The metal sheets 10 may be circumferential, for example non-sectorized circumferential metal sheets, and thus improve the sealing between the downstream support 4 and the sealing ring 2 by improving the sealing between the seal 5 and the radially protruding portion 2A and/or by improving the sealing between the seal 5 and the downstream support 4.

In the case where a metal sheet 10 surrounds the radially protruding portion 2A, as a replacement for the previous definition of the distance R1 relative to the sealing ring 2 alone, the distance R1 may be defined relative to the assembly of the sealing ring 2 and of the metal sheet mounted on the sealing ring 2.

In other words, the distance R1 can be defined at the radially outermost position of the assembly formed of the sealing ring 2 and of the metal sheet 10 mounted on the sealing ring.

In this way, the dismounting from upstream of the assembly of the sealing ring 2 and of the metal sheet 10 is possible.

It is understood that the turbine 107 can be devoid of one or both metal sheet(s) 10 between the downstream support 4 and the sealing ring 2 and between the seal 5 and the radially protruding portion 2A.

For example, in the embodiment of FIG. 3, the turbine 107 is devoid of metal sheet between the seal 5 and the radially protruding portion 2A.

In the embodiment of FIGS. 4 and 5, the turbines 107 are devoid of metal sheets between the downstream support 4 and the sealing ring 2 and between the seal 5 and the radially protruding portion 2A.

The turbine 107 may also be devoid of a seal between the sealing ring 2 and the downstream support 3.

In order to ensure the sealing between the sealing ring 2 and the downstream support 4 in the absence of a seal 5, the radially protruding portion 2A may for example have a first radial contact surface with a radially internal part of the downstream support 4, and a second radial contact surface with a radially external part of the downstream support 4.

In this way, the radially protruding portion 2A can grip the downstream support 4, so as to exert a force on the downstream support 4 making it possible to ensure the seal between the downstream support 4 and the sealing ring 2.

The downstream support 4 and/or the sealing ring 2 may be sectorized. Where applicable, the number of sectors forming the downstream support 4 is strictly smaller than the number of sectors forming the sealing ring 2.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

1. A turbine for a turbomachine, the turbine having a main axis and comprising an annular casing an upstream ring support, a downstream ring support and a sealing ring, the sealing ring being configured to extend around and radially face a blade assembly of a rotor of the turbine, wherein
the upstream ring support and the downstream ring support are mounted against a radially inner surface of the casing, the upstream ring support and the downstream ring support having an upstream end and a downstream end, the sealing ring being configured to be disposed radially between the blade assembly and the casing, and being mounted against the upstream ring support and the downstream ring support,
the sealing ring having a maximum radius with respect to the main axis, and the casing being dimensioned such that the maximum radius of the sealing ring is strictly smaller than the radius of the upstream end of the casing so as to allow a mounting by axial insertion, of the sealing ring and of the upstream ring support, against the downstream ring support,
the turbine comprising at least one C-shaped locking member configured to hold together in contact, inside the C-shape, an upstream end of the sealing ring and the upstream ring support.

2. The turbine for a turbomachine according to claim 1, wherein the sealing ring comprises a radially protruding portion, the maximum radius of the sealing ring being equal to the maximum radius of the radially protruding portion.

3. The turbine for a turbomachine according to claim 2, comprising at least one seal disposed between the downstream ring support and the radially protruding portion.

4. The turbine for a turbomachine according to claim 3, wherein the at least one seal extends axially.

5. The turbine for a turbomachine according to claim 3, comprising at least one sealing metal sheet disposed between the seal and the downstream ring support.

6-9. (canceled)

10. The turbine for a turbomachine according to claim 3, comprising at least one sealing metal sheet disposed between the seal and the radially protruding portion.

11. The turbine for a turbomachine according to claim 1, wherein the casing is a low-pressure turbine casing.

12. The turbine according to claim 1, wherein at least one among a downstream end of the sealing ring and a downstream end of the downstream ring support is received in a housing of an external platform of a downstream distributor.

13. The turbine according to claim 12, wherein the housing is a groove into which the at least one end is inserted axially.

14. A turbine for a turbomachine, the turbine having a main axis and comprising an annular casing, an upstream ring support, a downstream ring support and a sealing ring, the sealing ring being configured to extend around and radially face a blade assembly of a rotor of the turbine, wherein
the upstream ring support and the downstream ring support are mounted against a radially inner surface of the casing, the upstream ring support and the downstream ring support having an upstream end and a downstream end,
the sealing ring being configured to be disposed radially between the blade assembly and the casing, and being mounted against the upstream ring support and the downstream ring support,
the sealing ring having a maximum radius with respect to the main axis, and
the casing being dimensioned such that the maximum radius of the sealing ring is strictly smaller than the radius of the upstream end of the casing so as to allow a mounting by axial insertion, of the sealing ring and of the upstream ring support, against the downstream ring support,
at least one C-shaped locking member configured to hold together in contact, inside the C-shape, a downstream end of the sealing ring and the downstream ring support.

15. The turbine for a turbomachine according to claim 14, wherein the sealing ring comprises a radially protruding portion, the maximum radius of the sealing ring being equal to the maximum radius of the radially protruding portion.

16. The turbine for a turbomachine according to claim 15, comprising at least one seal disposed between the downstream ring support and the radially protruding portion.

17. The turbine for a turbomachine according to claim 16, wherein the at least one seal extends axially.

18. The turbine for a turbomachine according to claim 16, comprising at least one sealing metal sheet disposed between the seal and the downstream ring support.

19. The turbine for a turbomachine according to claim 16, comprising at least one sealing metal sheet disposed between the seal and the radially protruding portion.

20. The turbine for a turbomachine according to claim 18, wherein the casing is a low-pressure turbine casing.

21. The turbine according to claim 10, wherein at least one among a downstream end of the sealing ring and a downstream end of the downstream ring support is received in a housing of an external platform of a downstream distributor.

22. The turbine according to claim 21, wherein the housing is a groove into which the at least one end is inserted axially.

23. A turbomachine comprising the turbine according to claim 14.
